(19) United States
(12) Patent Application Publication
(10) Pub. No.: US 2023/0318312 A1
(43) Pub. Date: Oct. 5, 2023

(54) DYNAMIC FAST CHARGE FOR BATTERY BASED ON LENGTH OF TIME DEVICE WILL BE WITHOUT EXTERNAL POWER SOURCE

(71) Applicant: Lenovo (Singapore) Pte. Ltd., Singapore (SG)

(72) Inventors: Bouziane Yebka, Apex, NC (US); Tin-Lup Wong, Chapel Hill, NC (US); Philip J. Jakes, Durham, NC (US); Kenneth Seethaler, Raleigh, NC (US)

(21) Appl. No.: 17/710,610

(22) Filed: Mar. 31, 2022

(51) Int. Cl. H02J 7/00

(52) U.S. Cl. CPC H02J 7/00034; H02J 7/0048; H02J 7/007188

(57) ABSTRACT

In one aspect, an apparatus may include a processor and storage accessible to the processor. The storage may include instructions executable by the processor to determine a current state of charge of a battery and to determine a minimum length of time that a device will be powered by the battery to perform one or more tasks without an intervening connection to an external power source. The instructions may then be executable to dynamically determine, based on the current state of charge and the length of time, a first charge rate at which to charge the battery. The instructions may then be executable to charge the battery at the first charge rate prior to a beginning of the length of time. In various examples, the first charge rate may be faster or slower than a normal charge rate for the battery.

### FIELD

The disclosure below relates to technically inventive, non-routine solutions that are necessarily rooted in computer technology and that produce concrete technical improvements. In particular, the disclosure below relates to dynamic fast charging of a battery in a device based on a length of time the device will be without an external power source.

### BACKGROUND

As recognized herein, charging a battery at a faster rate than normal over the long term can lead to battery degradation and thermal damage. This in turn can lead to safety hazards as the battery degrades and can even lead to a thermal runaway situation. At the very least, it can negatively affect the overall life of the battery. But as also recognized herein, configuring battery hardware to charge at a relatively faster rate by default can also lead to undesirable results in that such batteries typically have less energy density than they otherwise would, may consume more space within the devices in which they are disposed as a larger battery would be used for achieving the same capacity, may require more materials to construct the batteries, and may even need a bigger power adapter for charging than would otherwise be used. There are currently no adequate solutions to the foregoing computer-related, technological problems.

### SUMMARY

Accordingly, in one aspect an apparatus includes at least one processor and storage accessible to the at least one processor. The storage includes instructions executable by the at least one processor to access data related to a task for which a computing device will be used prior to the computing device being engaged with an external power source. Based on the data, the instructions are executable to determine a first charge rate at which to charge a battery of the computing device. Then prior to a time at which the task will be performed using the computing device, the instructions are executable to charge the battery at the first charge rate.

In some example implementations, the first charge rate may be faster than a normal charge rate for the battery and/or a default charge rate for the battery.

Also in some examples, the data may include electronic calendar data that indicates the task.

Still further, in some example embodiments the instructions may be executable to determine the first charge rate based on the data, based on a current state of charge of the battery, and based on an amount of time remaining to charge the battery prior to the time at which the task is to be performed.

Additionally, if desired the instructions may be executable to, based on the data, determine an amount of battery power that will be consumed to perform the task using the computing device. In these examples, the instructions may be executable to determine the first charge rate based on the amount of battery power that will be consumed to perform the task using the computing device.

Moreover, in some examples the apparatus may include the battery itself.

Also, in various example implementations the apparatus may include the computing device, and the at least one processor may include a processor of the computing device. Additionally or alternatively, the apparatus may form part of a battery pack that houses the battery, and the at least one processor may include a processor in the battery pack.

In still another aspect, a method includes determining a current state of charge of a battery and determining a length of time that a device will be powered by the battery to perform one or more tasks without an intervening connection to an external power source. The method also includes determining, based on the current state of charge and the length of time, a first charge rate at which to charge the battery. Thereafter, the method includes charging the battery at the first charge rate prior to a beginning of the length of time.

In some examples, the method may be executed at least in part by a battery management unit (BMU) coupled to the battery. Additionally or alternatively, the method may be executed at least in part by a processor in the device.

In various example implementations, the length of time may be identified by the device based on one or more types of data to which the device has access. For example, the one or more types of data may include electronic calendar data for a user of the device and/or location data related to a current location of the device.

Still further, in some example embodiments the method may include determining, based on the current state of charge and the length of time, an amount by which the battery needs to charge prior to the beginning of the length of time. Based on the amount by which the battery needs to charge, the method may then include determining the first charge rate at which to charge the battery.

In some example embodiments, the first charge rate may be slower than a normal charge rate for the battery and/or a default charge rate for the battery.

In still another aspect, at least one computer readable storage medium (CRSM) that is not a transitory signal includes instructions executable by at least one processor to access data indicating a minimum length of time that a battery will be used to power a computing device prior to being connected to an external power source. The instructions are also executable to determine a current state of charge of the battery and, based on the data and the current state of charge, dynamically determine a first charge rate at which to charge the battery. The instructions are then executable to, prior to the minimum length of time beginning, charge the battery at the first charge rate.

In some examples, the first charge rate may be determined based on data in a relational database to which the at least one processor has access, where the relational database may indicate various charge rates for various respective lengths of time available.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows an example timeline of various available charge times for a battery as well as non-charge times during which a client device will use the battery consistent with present principles;

FIGS. 4 and 5 show an example data table that may be used to dynamically determine an appropriate charge rate for a battery consistent with present principles;

FIG. 6 illustrates example logic in example flow chart format that may be executed by a device consistent with present principles;

FIG. 7 shows an example graphical user interface (GUI) that may be presented on a display of a client device to prompt a user to charge a device's battery consistent with present principles; and

FIG. 8 shows an example settings GUI that may be presented on a display of a client device to configure one or more settings related to dynamic charging consistent with present principles.

### DETAILED DESCRIPTION

Among other things, the detailed description below discusses dynamic, intelligent fast charging of a battery to accelerate the charge as needed based on tasks and priorities of the device, thus preserving and prioritizing battery capacity and density as much as possible while also minimizing any potential thermal damage and shortened battery life due to the use of faster-than-normal charging rates.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

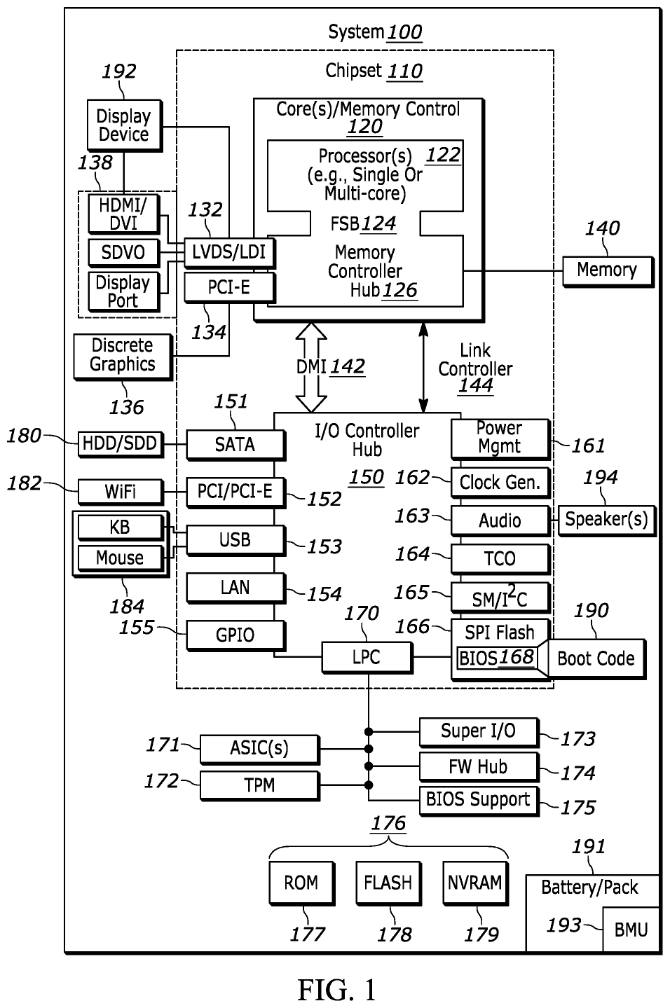

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may include a battery/battery pack 191. If a battery pack is used, in addition to containing one or more batteries with one or more respective battery cells, the battery pack 191 may include its own one or more processors, such as a microprocessor or any other type of processor that might be provided as part of a gas gauge or battery management unit (BMU) 193 for the battery pack 191. Non-transitory storage may also be included in the battery pack 191, with the storage storing firmware that may be used in some examples for dynamic charging as described herein. Random access memory (RAM) and other components may also be included in the battery pack 191, such as one or more sensors for sensing/measuring things related to the battery pack 191 and/or battery cells within such as temperature, voltage, electric potential, age, impedance, state of charge, etc. Thus, these sensors may provide input/measurements to the processor(s) within the battery pack 191 and/or the processor(s) 122.

Additionally, note that the one or more battery cells within the battery or battery pack 191 may be configured in jellyroll format. The cells may also be configured in pouch cell format in which the strip(s) of active material are folded, or in a stacked format if desired. Regardless, the battery cells may be Lithium ion battery cells or another type of battery cell.

It is to be further understood consistent with present principles that the battery pack 191 may be electrically coupled to and power the system 100, and/or individual components thereof, using battery power. The system 100 and/or battery back 191 in particular may also be electrically coupled to at least one charge receiver on the system 100 for receiving a charge via an AC/DC power supply connected to an AC power source (e.g., a wall outlet providing AC power) to charge the one or more battery cells in the pack 191. Thus, the charge receiver may include at least one circuit configured for receiving power from a wall outlet (or other AC power source) via the power supply and then providing power to the system 100 to power it and also providing power to the battery pack 191 to charge the cells within the pack 191. In some examples, wireless charging using a wireless charge receiver and wireless charge transmitting pad may be used.

Additionally, though not shown for simplicity, in some embodiments the system 100 may include an inertial measurement unit (IMU) that may include a gyroscope that senses and/or measures the orientation of the system 100 and provides related input to the processor 122, as well as an accelerometer that senses acceleration and/or movement of the system 100 and provides related input to the processor 122.

Still further, the system 100 may include an audio receiver/microphone that provides input from the microphone to the processor 122 based on audio that is detected, such as via a user providing audible input to the microphone. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video.

Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

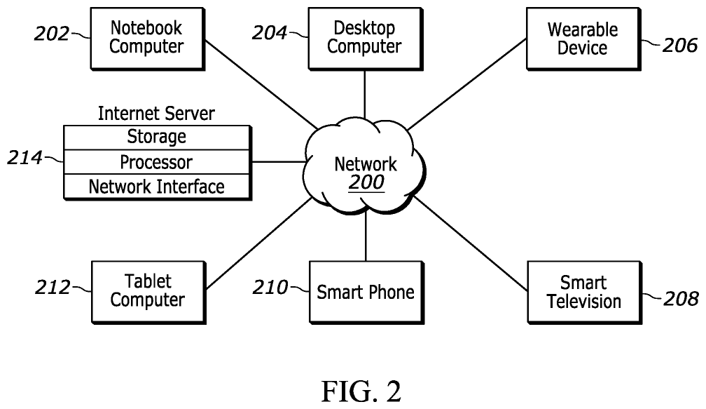

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

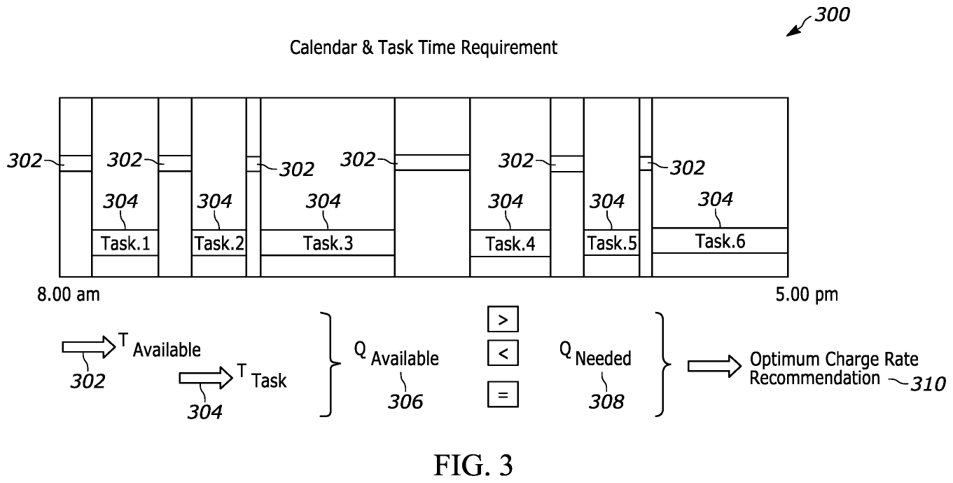

FIG. 3 shows an example timeline 300 of respective battery charge times available and respective times at which tasks will be executed by a computing device without receiving power from an external power source (such as a wireless battery charger and/or wired alternating current (AC) adapter). The tasks themselves and their associated times may be determined by a CPU or other processor within the device powered by the battery, and/or by a processor within the battery's battery management unit (BMU) specifically.

In the present example, the tasks may be determined based on electronic calendar data from an electronic calendar of an end-user (where the end-user may have already provided calendar access for the processor to make the determination). However, the tasks may additionally or alternatively be determined from other types of data as well, such as current time of day, current location, an activity determination made based on sensor data such as inertial measurement unit (IMU) data, etc. For example, data from an accelerometer or gyroscope on the device may be processed using a pattern recognition algorithm and predefined motion patterns to identify a particular activity from the inertial sensor data (e.g., data indicative of brisk walking, from which the device may infer the user is about to enter a meeting or board a flight).

In any case, identifiers 302 and 304 for the timeline 300 indicate respective consecutive times from 8:00 a.m. to 5 p.m. on a particular day. As may be appreciated from FIG. 3, for a given available charge time 302 before a respective task 304, the device may determine whether an amount of battery power currently available 306 is greater than, less than, or equal to an amount of battery power needed or that will be consumed 308 for the device to remain powered on and able to execute the predicted task (for the duration of the respective length of time of the respective task 304 itself, during which external power may not be available to charge the battery or power the device). This may be determined from the respective available time 302 and respective task 304 that follows as well as data in a relational database as will be described in more detail in a moment. But for now, understand that the determination may result in an output of an optimum charge rate recommendation 310 indicating a particular charge rate at which to charge the battery so that the battery has enough charge to execute the respective predicted task 304 until the battery can be charged again during a subsequent available charge time 302.

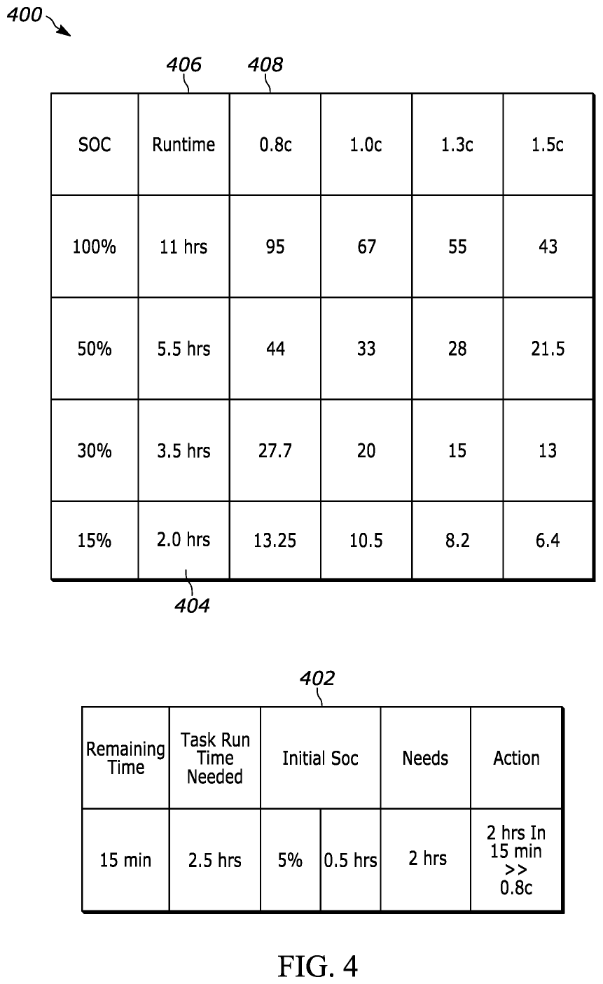

Now in reference to FIG. 4, this figure shows an example relational database that may be used, which in the present example takes the form of an example data table 400. As shown in the legend 402, fifteen minutes of available charge time remains to charge a device's battery for at least two and a half hours of runtime using power from the battery. The legend 402 also shows that the initial or current state of charge of the battery is five percent, which by itself would result in half an hour of runtime. The device may thus compute, as further indicated on the legend 402, that two hour's worth of additional battery charge is needed to power the device for the entire two and a half hours of runtime. Based on this, the device may take action by charging the battery at a rate of 0.8C to charge the battery by an additional two hours of runtime within the fifteen minutes of remaining time left to charge.

Note that this assumes the user has or will promptly engage the battery's charger with a wall outlet or other power source to charge the battery. If the battery does not begin receiving a charge within a threshold amount of time of the initial determination of the appropriate charge rate to use (and/or within a threshold amount of time of presentation of a prompt like the prompt 700 described below), the device may begin anew to dynamically determine, based on the new amount of time remaining, another charge rate to use. Thus, the threshold may be a length of time during which the device can still accurately apply a charge at the determined rate to achieve the desired charge level within the available charge time (without the battery further draining by an amount that would result in the battery not being chargeable to the desired charge level at the determined rate within the available time). Thus, it is to be understood that the minimum charge time needed in a given instance to charge the battery to the desired charge level using the determined rate may not be the same as the total amount of time available to charge. This is illustrated in the table 400.

Thus, as shown for the example indicated in FIG. 4, to charge the battery by two hours of runtime (which is to charge the battery by fifteen percent state of charge), the device may locate the two hours entry 404 in column 406 to then proceed across that row to locate the first entry, from left to right according to the arrangement shown, that is equal to or less than fifteen minutes. In the present example, a charge rate of 0.8C as indicated in column 408 would charge the battery to the desired level in thirteen minutes and twenty five seconds (which is less than the fifteen minutes available). Accordingly, the device may charge the battery within the time available at a rate of 0.8C.

Also note before moving on that while an even faster charge rate could be used (such as using a charge rate of 1.0C for a ten and a half minute charge as also indicated in the same row), that would charge the battery unnecessarily fast in this example circumstance and doing so over time may result in additional battery degradation and shorter battery life than using a slower charge rate where possible (0.8C here). Further note that battery life may be extended by using slower charge rates such as 0.8C when time permits even if, for example, 1.0C is the normal and/or default charge rate for the battery.

What's more, also note that the relational databases described herein (including the table 400) may be created or populated by a device developer or battery manufacturer based on pre-sale charge testing of the battery itself using the specific charger/AC adapter that will be sold with the battery. This may be done so that the respective database that is used for a given battery of various specifications (e.g., energy density, capacity, and chemical composition) may be specific to that battery as well as the charge rates that are possible for the specific charger/AC power adapter that will be used (e.g., a 25 watt charger, or a 135 watt charger).

Now in reference to FIG. 5, another example is illustrated using the same table 400 described above. Here, legend 500 indicates that fifteen minutes of available charge time remains to charge the device's battery for a predicted six and a half hours of runtime. The legend 500 also shows that the initial or current state of charge of the battery is thirty percent, which by itself would result in three hours of runtime. The device may thus compute, as further indicated on the legend 500, that three and a half hours worth of additional battery charge is needed to power the device for the entire six and a half hours of runtime.

The device may compute as much by locating the three and a half hours entry 502 in column 406 to then proceed across that row to locate the first entry, from left to right according to the arrangement shown, that is equal to or less than fifteen minutes. In the present example, a charge rate of 1.0C is too slow as that would take twenty minutes to charge to the desired level, but a charge rate of 1.3C as indicated in column 504 would charge the battery in fifteen minutes (equal to the fifteen minutes available). Accordingly, the device may take action by charging the battery at a rate of 1.3C to charge the battery by an additional three and a half hours of runtime within the fifteen minutes of remaining time left to charge.

Here again note that while a faster charge rate could also be used in this example, that may charge the battery unnecessarily fast and possibly result in unnecessary battery degradation and shortened battery life. Thus, an optimal charge rate may be selected for a given circumstance here too while also extending battery life as much as possible using the slowest charge rate that could be used for the particular circumstance at hand.

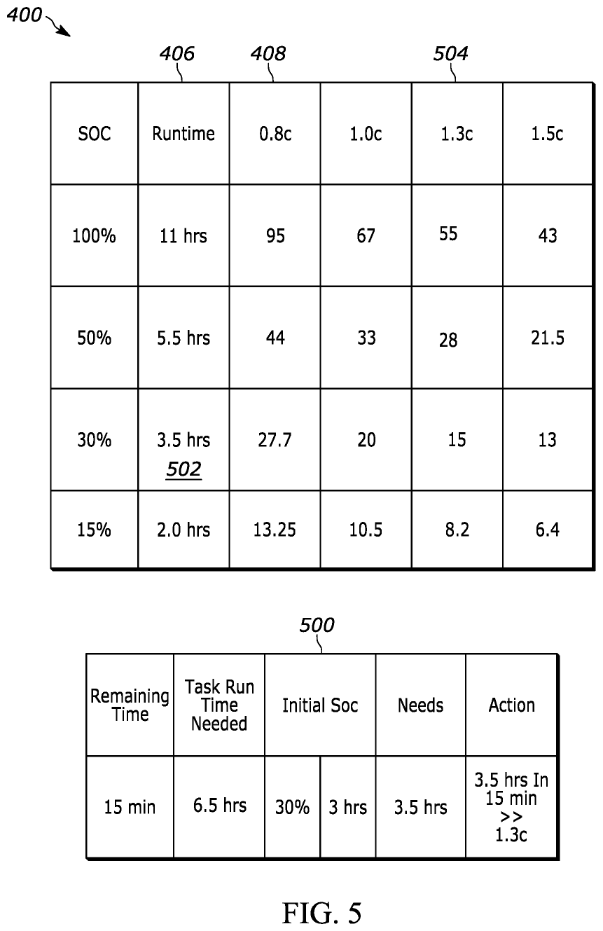

Continuing the detailed description in reference to FIG. 6, it shows example logic that may be executed by one or more devices consistent with present principles. Note that while the logic of FIG. 6 is shown in flow chart format, other suitable logic may also be used. Further note that the logic may be executed in any appropriate combination by a processor in a battery pack/BMU, by another processor within the client device itself such as a central processing unit (CPU), and/or by a processor of a remotely-located server in communication with the corresponding client device.

Beginning at block 600, the device may access data related to a task for which the client computing device will be used prior to the client device being engaged again with an external power source for charging the battery. According to the example described below in reference to FIG. 6, this data may include a current time of day and electronic calendar data that indicates the task through one or more entries in the calendar (which in the present example includes an entry spanning a length of time that an airplane flight will last that the client device's user is about to take).

Accordingly, assuming the user will use the client device during the flight, the task may be identified as, for example, executing one or an average amount of applications (apps), functions, etc. for a time span covering the entire length of time of the flight itself. The average amount may be determined from a device history for that particular end user and/or client device, where the history may indicate past device/app usage statistics in general and/or for various specific situations and apps (such as specific apps used on past airplane flights) as well as the corresponding amount of battery drain that occurred. Additionally or alternatively, the average amount may be determined based on a similar history for other users and/or other devices, based on data from the client device developer or manufacturer indicating the average to apply in general and/or for various specific situations (as well as the corresponding battery drain), and/or based on a predicted future amount of applications, functions, etc. (not based on history) as might already be used for indicating a percentage of battery power remaining in a taskbar presented on the client device's display. Thus, however determined, the average amount of apps, functions, etc. may be used to identify, from the histories or predictions, a minimum amount of battery power (e.g., state of charge) that will be consumed to perform the upcoming task during the duration of the flight or other calendar event.

Then at block 602 the device may determine the current state of charge of the battery, as may be reported by the battery's BMU. Thereafter, at block 604 the device may determine the minimum length of normal charge time that would be needed to charge the battery from its current state of charge to the minimum total state of charge needed for execution of the task(s) as already determined at block 600 per the description above (e.g., without the battery running out of power or needing an intervening charge from an external power source for additional runtime). This length of time may be determined based on local or remotely-stored data from the client device/battery manufacturer that indicates one or more charge times at the normal rate. Accordingly, note that the charge times at different states of charge may or may not be the same in that, for example, “top off” charging to charge the battery from ninety five percent to one hundred percent may take longer at the normal charge rate than charging five percent but from fifty percent to fifty five percent state of charge at the normal charge rate, and accordingly the data from the manufacturer may indicate as much.

In any case, the logic of FIG. 6 may next proceed to block 606 where, based on the current time of day (as may be identified from a clock application executing at the client device), and based on the length of time from the current time until the beginning of the flight or other event indicated in the electronic calendar, the device may determine an amount of charge time actually available to charge the battery to the state of charge needed to last for the duration of the task or other length of time during which the device will operate on only battery power.

From block 606 the logic may then proceed to decision diamond 608 where the device may determine whether the charge time available or remaining (as determined at block 606) is greater than or equal to the minimum charge time needed to charge the battery by the desired amount at the normal charge rate to last for the length of the flight (or other upcoming electronic calendar event).

Responsive to an affirmative determination at diamond 608, the logic may proceed to block 610 where the device may select the normal charge rate for charging the battery or may access a relational database (like the table 400) to dynamically determine a slower charge rate to use. The logic may then proceed from block 610 to block 612 to charge the battery within the charge time available at the normal or slower charge rate (prior to the task/length of time beginning). Thereafter, the logic may proceed to block 614 where the logic may end. Or at block 614 the logic may revert back to block 600 to proceed again therefrom to reassess the current charge instance as the charge continues (e.g., for accuracy and to possibly dynamically increase or decrease the charge rate if less or more time becomes available, or if charging ends up being slower or faster than expected). Or the logic may revert back to block 600 to perform charge rate determinations for another charging instance.

However, further note that responsive to a negative determination at diamond 608, the logic may instead proceed to block 616 where the device may access a relational database (again like the table 400) to dynamically determine a faster-than-normal charge rate to use. The logic may then proceed to block 618 where the device may charge the battery within the charge time available at the determined faster charge rate (again prior to the task/length of time beginning). After block 618 the logic may then proceed to block 614 as already described above.

Notwithstanding the calendar example described in reference to FIG. 6 above, note that tasks and priorities for which the client device may be used may be determined other ways as well. For example, the device may receive current geolocation data from a GPS transceiver on the device, determine a type of establishment associated with the current location using a maps/navigation app or other public data, and then determine an activity for which the device will be used based on the type of establishment. E.g., data may be accessed that indicates various activities/tasks that might be performed for respective establishment types.

For example, if the establishment is a grocery store, the device may determine that a notes application will be launched and that the device's display will be powered on for a certain preestablished average amount of time to present a screen of the notes application while the user is in the grocery store (to present a grocery list). As another example, if the establishment is a restaurant, the device may determine that a payment processing application will be only briefly launched and executed to process a payment for the meal toward the end of the meal itself, and so not as much battery power would be required to get the device through the duration of its time at the restaurant location as opposed to its time at the grocery store location.

As another example, an activity/task determination made based on sensor data such as IMU data. For example, data from an accelerometer or gyroscope on the device may be processed as described above to identify brisk walking, implying the user is about to enter a meeting or board a flight for which the device may be assumed it will be actively used and have its display powered on for the entire duration of the meeting or flight. And if calendar data, email data, or other data is not available that would indicate the length of the meeting or flight, a default length of time may be assumed. Furthermore, in such an instance a reminder prompt like the prompt 700 (which will be described shortly) may also be presented to the user.

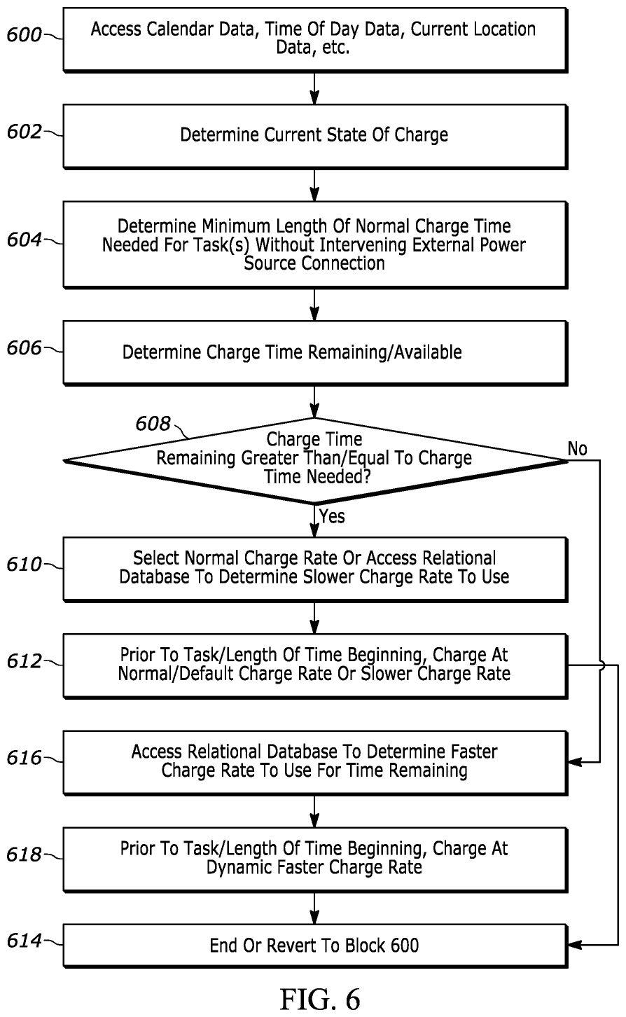

However, first as another example, if physical activity such as a gym workout or tennis match is inferred from the IMU data, the device may assume that the device's display itself may not be illuminated during the physical activity (thus requiring relatively less battery power over time) but that a fitness tracker application may still be executed at the device during the physical activity to track the user's steps, heart rate, etc. The device, knowing how much battery power per time increment the fitness tracker application uses on average to run in the background (e.g. based on a usage history), may then determine how much battery power will be needed for an assumed default length of time of the activity itself and, in some instances, may also present a reminder prompt like the prompt 700 of FIG. 7.

Accordingly, FIG. 7 will now be described. This figure shows an example prompt/graphical user interface (GUI) 700 that may be presented on the display of a client device housing or otherwise powered by a battery that will have to be charged for sufficient runtime to get through an identified task or activity consistent with present principles. As shown in FIG. 7, the GUI 700 may include a text indication 702 that the device has determined that the end-user has fifteen minutes available before his/her flight begins boarding. Again note that this available amount of time may have been determined from different types of data such as, for example, electronic calendar data, a purchase confirmation email for the flight as received at the user's email account/application and scanned by the device, and/or publicly-available data from FlightAware or another website that provides data indicating a current actual boarding time of the flight given any recent flight delays or other recent flight updates.

As also shown in FIG. 7, the indication 702 may indicate that based on the device's current estimates, including its current state of charge remaining, the device will need an additional fifteen percent of charge above its current state of charge to be able to power the device through the duration of the flight itself and possibly to power the device for a threshold amount of time beyond the end time of the flight or other activity (e.g., to ensure adequate battery power to power a maps application for the user to subsequently navigate by car from the arrival airport to the user's ultimate destination at the arrival city even if the battery is not charged once the user arrives at the arrival airport itself). Thus, for example, the device may add a threshold state of charge amount of another five percent to account for the threshold amount of time beyond conclusion of the flight, and so the fifteen percent state of charge that is indicated on the GUI 700 as being needed may include this additional threshold five percent state of charge.

In any case, FIG. 7 also shows that a prompt 704 may prompt the user to engage the charger with the device's battery in the next two minutes for sufficient charging at the dynamically-determined rate for the battery to have enough charge for the flight (and possibly threshold time thereafter). Note here that in certain examples the indication of two minutes may take the form of a dynamic counter or timer that decreases in real time as time goes on and the user does not initiate charging for the device to then charge the battery at the dynamically-determined rate. Then if the user still does not begin charging the battery by the time the counter or timer hits zero and a different charge rate is ultimately needed, the counter or timer may be refreshed to count down again from a certain time determined based on the new charge rate. Also note here that though not shown for simplicity, in various examples the counter or timer may be accompanied by a text indication on the GUI 700 of the actual charge rate to which the counter pertains (the relevant dynamically-determined charge rate).

Still in reference to FIG. 7, should the user wish to dismiss the GUI 700, the user may then direct touch or cursor or other input to the selector 706 to do so. However, if the user thinks he/she will not be able to charge the battery prior to the beginning of the flight, the user may instead select the selector 708 to in turn command the device to enter a power saver mode where certain device functions and communications may be limited to further extend the battery's life on the current state of charge.

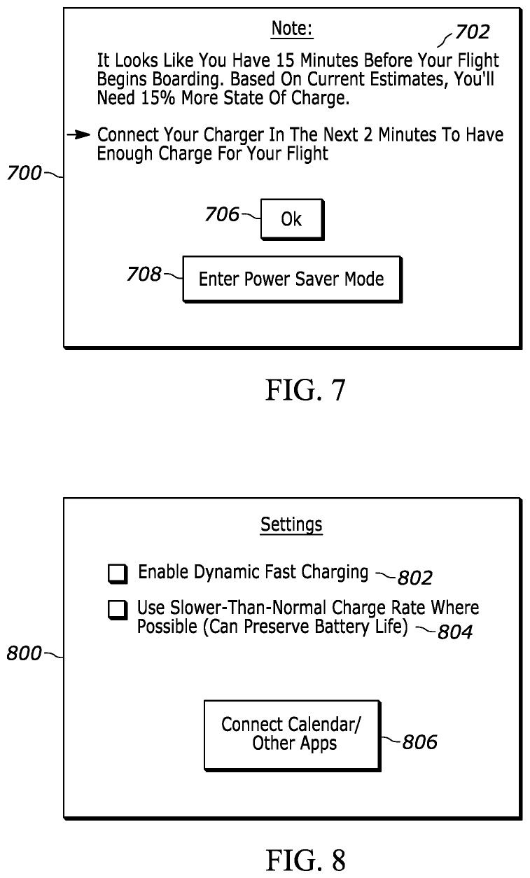

Before moving on to FIG. 8, also note that haptic and audible notifications may be presented in addition to or in lieu of the GUI 700. For example, a digital assistant may be executed to read aloud, using text to speech software and the device's speaker(s), the text 702 and 704 presented as part of the GUI 700 (and to even audibly provide a count down by the second and/or minute according to the counter or timer described above).

Turning now to FIG. 8, it shows an example GUI 800 that may be presented on a display of a client device to configure one or more settings of the client device to operate consistent with present principles. For example, the GUI 800 may be presented on the display of the device undertaking the logic of FIG. 6. The settings GUI 800 may be presented to set or enable one or more settings of the device to operate consistent with present principles, including dynamically determining different charge rates to use to charge a battery. The GUI 800 may be reached by, for example, navigating a battery app menu or a settings menu of the client device's operating system. Also note that in the example shown, each option discussed below may be selected by directing touch or cursor input to the respective check box adjacent to the respective option.

Accordingly, as shown in FIG. 8, the GUI 800 may include an option 802 that may be selectable to set or configure the device, system, software, etc. to undertake present principles in the future. For example, the option 802 may be selected a single time to enable the device to dynamically determine different charge rates to use to charge a battery in different charge instances in the future.

The GUI 800 may also include an option 804 that may be selectable to specifically set or enable the device to not just use faster-than-normal charge rates when needed for a given situation, but to also use slower-than-normal charge rates where possible to further preserve battery life, reduce thermal damage from charging, etc. FIG. 8 also shows that the GUI 800 may include a selector 806 that may be selectable to initiate a process where the user connects or links his/her electronic calendar or other appropriate apps to the battery app or other software being executed to dynamically determine charge rates as described herein.

Moving on from FIG. 8 but to provide a few more examples consistent with present principles, also note that a task or function as described herein may also be determined based on images from a camera and/or input from a microphone. For example, object recognition and gesture recognition may be executed on the images to determine an activity of the user and a corresponding task that the device might execute during the user's activity. Likewise, natural language processing may be executed on the microphone input to determine, based on words audibly spoken from the user, an activity of the user and corresponding task that the device might execute during the user's activity.

It may now be appreciated that present principles provide for an improved computer-based user interface that increases the functionality and ease of use of the devices disclosed herein while also allowing for batteries with optimal energy density for a given application, longer battery life, and better thermal management while still balancing the need for fast charging in certain situations. The disclosed concepts are thus rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. An apparatus, comprising:
at least one processor; and
storage accessible to the at least one processor and comprising instructions executable by the at least one processor to:
access data related to a task for which a computing device will be used prior to the computing device being engaged with an external power source;
based on the data, determine a first charge rate at which to charge a battery of the computing device; and
prior to a time at which the task will be performed using the computing device, charge the battery at the first charge rate.

2. The apparatus of claim 1, wherein the first charge rate is faster than one or more of: a normal charge rate for the battery, a default charge rate for the battery.

3. The apparatus of claim 1, wherein the data comprises electronic calendar data that indicates the task.

4. The apparatus of claim 1, wherein the instructions are executable to:
based on the data and based on a current state of charge of the battery, determine the first charge rate.

5. The apparatus of claim 1, wherein the instructions are executable to:
based on the data and based on an amount of time remaining to charge the battery prior to the time at which the task is to be performed, determine the first charge rate.

6. The apparatus of claim 1, wherein the instructions are executable to:
based on the data, based on a current state of charge of the battery, and based on an amount of time remaining to charge the battery prior to the time at which the task is to be performed, determine the first charge rate.

7. The apparatus of claim 1, wherein the instructions are executable to:
based on the data, determine an amount of battery power that will be consumed to perform the task using the computing device; and
based on the amount of battery power that will be consumed to perform the task using the computing device, determine the first charge rate.

8. The apparatus of claim 1, comprising the battery.

9. The apparatus of claim 1, wherein the apparatus comprises the computing device, and wherein the at least one processor comprises a processor of the computing device.

10. The apparatus of claim 1, wherein the apparatus forms part of a battery pack that houses the battery, and wherein the at least one processor comprises a processor in the battery pack.

11. A method, comprising:
determining a current state of charge of a battery;
determining a length of time that a device will be powered by the battery to perform one or more tasks without an intervening connection to an external power source;
determining, based on the current state of charge and the length of time, a first charge rate at which to charge the battery; and
prior to a beginning of the length of time, charging the battery at the first charge rate.

12. The method of claim 11, wherein the method is executed at least in part by a battery management unit (BMU) coupled to the battery.

13. The method of claim 11, wherein the method is executed at least in part by a processor in the device.

14. The method of claim 11, wherein the length of time is identified by the device based on one or more types of data to which the device has access.

15. The method of claim 14, wherein the one or more types of data comprise electronic calendar data for a user of the device.

16. The method of claim 14, wherein the one or more types of data comprise location data related to a current location of the device.

17. The method of claim 11, wherein the method comprises:
determining, based on the current state of charge and the length of time, an amount by which the battery needs to charge prior to the beginning of the length of time; and
based on the amount by which the battery needs to charge, determining the first charge rate at which to charge the battery.

18. The method of claim 11, wherein the first charge rate is slower than one or more of: a normal charge rate for the battery, a default charge rate for the battery.

19. At least one computer readable storage medium (CRSM) that is not a transitory signal, the at least one computer readable storage medium comprising instructions executable by at least one processor to:
access data indicating a minimum length of time that a battery will be used to power a computing device prior to being connected to an external power source;
determine a current state of charge of the battery;
based on the data and the current state of charge, dynamically determine a first charge rate at which to charge the battery; and
prior to the minimum length of time beginning, charge the battery at the first charge rate.

20. The CRSM of claim 19, wherein the first charge rate is determined based on data in a relational database to which the at least one processor has access, the relational database indicating various charge rates for various respective lengths of time available.
